(19) United States
(12) Patent Application Publication
(10) Pub. No.: US 2024/0249375 A1
(43) Pub. Date: Jul. 25, 2024

(54) PROBABILITY BASED AUTOMATED TRANSPORTATION SERVICE REQUEST GENERATION

(71) Applicant: Hitachi, Ltd., Tokyo (JP)

(72) Inventors: Malarvizhi SANKARANARAYANASAMY, Mountain View, CA (US); Ravigopal VENNELAKANTI, San Jose, CA (US); Prasun Kumar SINGH, San Jose, CA (US); Ramyar SAEEDI, Santa Clara, CA (US); Rahul VISHWAKARMA, Berkeley, CA (US); Shouchun PENG, San Jose, CA (US)

(21) Appl. No.: 18/100,981

(22) Filed: Jan. 24, 2023

(51) Int. Cl. G06Q 50/30; G06Q 10/0637

(52) U.S. Cl. CPC G06Q 50/30; G06Q 10/0637; G06Q 10/0631

(57) ABSTRACT

In example implementations described herein, there are systems and methods for providing service partner recommendations in a transportation network associated with a plurality of transit-oriented service providers. The systems and method may include receiving a request for a service related to at least one aspect of the transportation network; obtaining information regarding a current state of the transportation network, where the information regarding the current state of the transportation network includes a set of service-preference parameters for the plurality of transit-oriented service providers; generating, based on an analysis of the request for the service and the information regarding the current state of the transportation network, a set of recommended partners and a set of recommended agreement parameters; and outputting the set of recommended partners and the set of recommended agreement parameters to at least one service provider in the plurality of transit-oriented service providers for acceptance.

### BACKGROUND

### Field

The present disclosure is generally directed to multimodal transportation networks. The present disclosure is further directed to providing a platform for multiple participants and/or service providers of the multimodal transportation network (e.g., a multimodal ecosystem) to identify opportunities for mutually beneficial partnerships and to generate service level agreements.

### Related Art

To establish mobility as a service (MaaS) across multiple modes of transportation (multimodal mobility) requires participation from participants (e.g., service providers, transit operators, regulators) across a mobility ecosystem. Operationalization requires participation from different stakeholders across the mobility ecosystem, who may also be competitors. Currently some multimodal mobility services are limited to providing a digital platform for displaying the options, routes, and cost to the riders. In all these current services there is minimal, or no, input delivered based on the rider selection to the transit operator/service provider. Additionally, each transit operator maintains their own service analytics for fleet operations. However, to realize the value of a system for MaaS requires the transit operators and service providers to establish real-time partnership to execute rider journeys and a data driven framework which provides visibility regarding the partners/ecosystem conditions in addition to the operators system condition (e.g., a traffic management system).

Mobility integration may be generalized to occur to different degrees across four realms. A first, physical realm of integration, may refer to smaller hard-infrastructure integration, which allows for easy access and interchanges between different modes of transport, such as building stations that service multiple types of transport. A second, network realm of integration, may refer to the larger hard-infrastructure investments that need to take place to ensure integration across modes of transport, such as rail and bus systems. In some aspects, the network realm may also include aspects such as building or dedicating roads for feeder services for trunk routes and is therefore closely related to physical integration. It is often the most expensive form of integration.

A third, operational realm of integration, may include several different soft-infrastructure aspects, including routing alignment, aligning timetabling, ticketing, and fares, and providing information to consumers on links between modes. All of these facilitate transfers between different mobility modes. This is a more complex form of integration but has been facilitated by various technological innovations. A fourth, institutional realm of integration, may refer to integration at the policy and institutional level and may be one of the most difficult forms of integration.

### SUMMARY

Example implementations described herein involve an innovative method for identifying and/or discovering incentives (e.g., service value based incentives) for participation in a partnership agreement in a multimodal mobility ecosystem and a system which provides the means to evaluate the incentives and automate the entire partner service request generation process. The example implementations may achieve the fourth realm of institutional integration. Institutional integration, in some aspects, may include coordination between, or merging, different agencies responsible for transport at various levels of government as well as private providers. In some aspects, institutional integration may also include coordination between institutions responsible for transport and land-use planning. Institutional integration may often be the form of integration that takes the longest to achieve. The example implementations may achieve multimodal integration by providing a functional interlink between operational (soft digital infrastructural components including routing alignment; aligning timetabling, ticketing, and fares; and providing information to consumers on links between different transportation modes) and institutional realms (digital integration of large organizational constraints such as regulatory and policy requirements), thereby accelerating the implementation of institutional integration and enabling the transit operators to realize the benefit of engagement in a multimodal mobility consortium.

Aspects of the present disclosure include a method for providing service partner recommendations in a transportation network associated with a plurality of transit-oriented service providers. The method may include receiving a request for a service related to at least one aspect of the transportation network; obtaining information regarding a current state of the transportation network, where the information regarding the current state of the transportation network includes a set of service-preference parameters for the plurality of transit-oriented service providers; generating, based on an analysis of the request for the service and the information regarding the current state of the transportation network, (1) a set of recommended partners to provide the (transit-oriented) service and (2) a set of recommended agreement parameters associated with the (transit-oriented) service; and outputting the set of recommended partners and the set of recommended agreement parameters to at least one service provider in the plurality of transit-oriented service providers for acceptance.

Aspects of the present disclosure include a non-transitory computer readable medium, storing instructions for execution by a processor, which can involve instructions for receiving a request for a service related to at least one aspect of the transportation network; obtaining information regarding a current state of the transportation network, where the information regarding the current state of the transportation network includes a set of service-preference parameters for the plurality of transit-oriented service providers; generating, based on an analysis of the request for the service and the information regarding the current state of the transportation network, (1) a set of recommended partners to provide the (transit-oriented) service and (2) a set of recommended agreement parameters associated with providing the (transit-oriented) service; and outputting the set of recommended partners and the set of recommended agreement parameters to at least one service provider in the plurality of transit-oriented service providers for acceptance.

Aspects of the present disclosure include a system, which can involve means for receiving a request for a service related to at least one aspect of the transportation network; obtaining information regarding a current state of the transportation network, where the information regarding the current state of the transportation network includes a set of service-preference parameters for the plurality of transit-oriented service providers; generating, based on an analysis of the request for the service and the information regarding the current state of the transportation network, (1) a set of recommended partners to provide the (transit-oriented) service and (2) a set of recommended agreement parameters associated with providing the (transit-oriented) service; and outputting the set of recommended partners and the set of recommended agreement parameters to at least one service provider in the plurality of transit-oriented service providers for acceptance.

Aspects of the present disclosure include an apparatus, which can involve a processor, configured to receive a request for a service related to at least one aspect of the transportation network; obtain information regarding a current state of the transportation network, where the information regarding the current state of the transportation network includes a set of service-preference parameters for the plurality of transit-oriented service providers; generate, based on an analysis of the request for the service and the information regarding the current state of the transportation network, (1) a set of recommended partners to provide the (transit-oriented) service and (2) a set of recommended agreement parameters associated with providing the (transit-oriented) service; and output the set of recommended partners and the set of recommended agreement parameters to at least one service provider in the plurality of transit-oriented service providers for acceptance.

### BRIEF DESCRIPTION OF DRAWINGS

FIG. 1 is a diagram illustrating an example multimodal traffic management system according to some aspects of the disclosure.

FIG. 2 is a diagram illustrating an implementation of a system incorporating at least one blockchain oracle in accordance with some aspects of the disclosure.

FIG. 3 is a diagram illustrating a high-level outline of an execution mechanism in accordance with some aspects of the disclosure.

FIG. 4 is a diagram illustrating a process performed by a MaaS system in accordance with some aspects of the disclosure.

FIG. 5 is a diagram illustrating a mechanism for marketplace operations in accordance with some aspects of the disclosure where the objectives is related to energy saving and/or greenhouse gas emission goals.

FIG. 6 is a call flow diagram illustrating example interactions between a multimodal partner management system (MPMS), a first operator, a second operator, a third operator, and a fourth operator for ridership-based partnerships in a mobility ecosystem in accordance with some aspects of the disclosure.

FIG. 7 illustrates a continuation of the example beginning in FIG. 6 in accordance with some aspects of the disclosure.

FIG. 8 is a flow diagram illustrating a method in accordance with some aspects of the disclosure.

FIG. 9 is a flow diagram illustrating a method in accordance with some aspects of the disclosure.

FIG. 10 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations described herein involve an innovative method for identifying incentives for participation in a multimodal ecosystem and a system which provides the means to evaluate the incentives and automate the entire partner service request generation process. For example, to transition from a siloed operation mode (e.g., in which each participant in the multimodal transit network maintains information regarding its own operations but does not have access to information regarding other participants) to a multimodal operation mode, in some aspects, the method and/or system may define the incentives of multimodal ecosystems, establish a single (shared) truth (or view of the system/network), and promote time critical partnership for combined operations. In some aspects, the method and/or system may generate a service request from a partner in a mobility ecosystem (e.g., multimodal transmit network) based on probability of acceptance and maximizing returns for the participants. An incentivization strategy and mechanism, in some aspects, may be implemented via one or more dynamic service level agreements (SLAs) between organizations managed by smart contract. The SLAs, in some aspects, may relate to energy solution modules for tracking, scoring, and/or offsetting carbon, water and/or other resource usage thereby promoting sustainable collaborations.

The method and/or system, in some aspects, may enable real-time dynamic exchange/partnerships in the mobility ecosystems. For example, the method and/or system may provide the following functionalities: identifying and/or defining opportunities for engagements and/or agreements, identifying profitable partners, defining rules of engagement and/or terms of agreements, and/or automating the process (e.g., the process from identifying opportunities to obtaining agreed-upon SLAs).

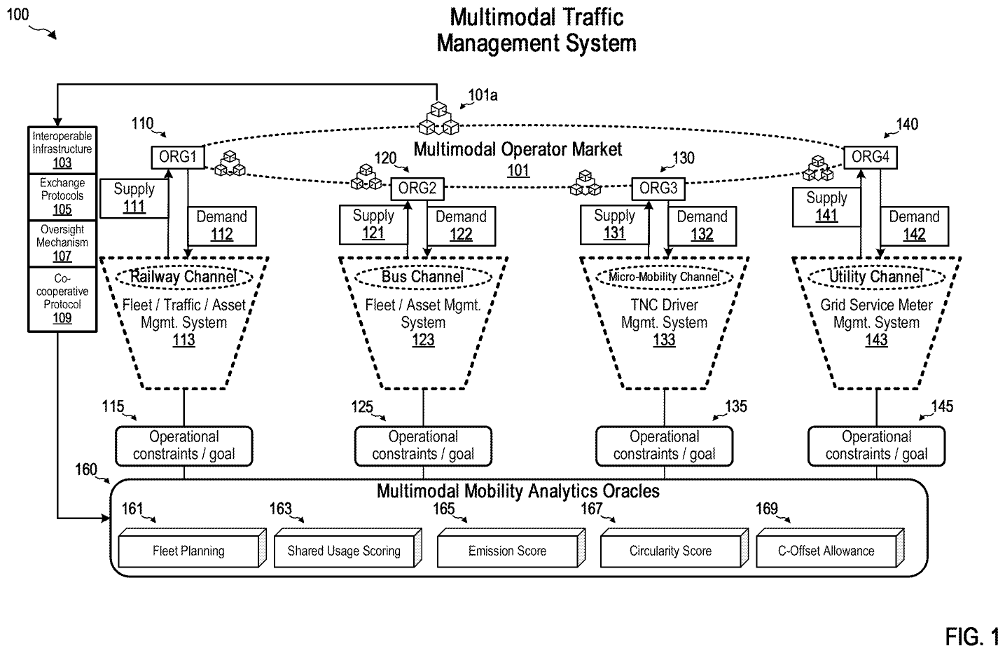

FIG. 1 is a diagram 100 illustrating an example multimodal traffic management system according to some aspects of the disclosure. The multimodal traffic management system, in some aspects, may include a multimodal operator market 101 associated with a blockchain oracle 101a (e.g., a data structure or data aggregator for organizing data from multiple operators associated with the multimodal operator market 101). The multimodal operator market 101, in some aspects, may be associated with a set of at least two component blockchain oracles (e.g., each component blockchain oracle being a data structure or data aggregator for organizing data from a particular operator, provider, or other market participant). For example, diagram 100 illustrates a multimodal operator market with a set of four component blockchain oracles including a first component blockchain oracle 110, a second component blockchain oracle 120, a third component blockchain oracle 130, and a fourth component blockchain oracle 140. In some aspects, each of the component blockchain oracles 110-140 may be associated with a corresponding mode of transit or service provider (e.g., a rail mode of transit 113, a bus mode of transit 123, a micro-mobility mode of transit 133, and a utility provider 143). Each component blockchain oracle 110, 120, 130, and 140 may collect, organize, and/or provide corresponding supply information 111, 121, 131, and 141, and demand information 112, 122, 132, and 142, respectively to a corresponding market participant (e.g., an operator of a rail mode of transit 113, an operator of a bus mode of transit 123, an operator of a micro-mobility mode of transit 133, and a utility provider 143).

The component blockchain oracles may provide the supply information 111-141 and the demand information 112-142 to the blockchain oracle 101a for integration. The blockchain oracle 101a may then process the data based on a set of functions, components, and/or algorithms (e.g., interoperable infrastructure 103, exchange protocols 105, oversight mechanism 107 and co-operative protocol 109) to provide a set of data for a set of multimodal mobility analytics oracles 160. The set of multimodal mobility analytics oracles 160, in some aspects, may include separate analytics modules (or oracles). For example, the set of multimodal mobility analytics oracles 160 as illustrated includes a fleet planning module 161, a shared usage scoring module 163, an emissions score module 165, a circularity score module 167, and a carbon-offset allowance module 169. The set of multimodal mobility analytics oracles 160, in some aspects, may also receive sets of operational constraints and/or goals (e.g., objectives) 115, 125, 135, and 145, associated with the rail mode of transit 113, the bus mode of transit 123, the micro-mobility mode of transit 133, and the utility provider 143, respectively. The sets of operational constraints and/or goals 115, 125, 135, and 145, in some aspects, may be transmitted by, or received from, the operators directly and/or may be received via the blockchain oracle 101a (e.g., via the component blockchain oracles 110-140). The sets of operational constraints and/or goals 115-145, in some aspects, may be used to define a set of objective functions to be optimized for making recommendations as will be discussed in more detail below.

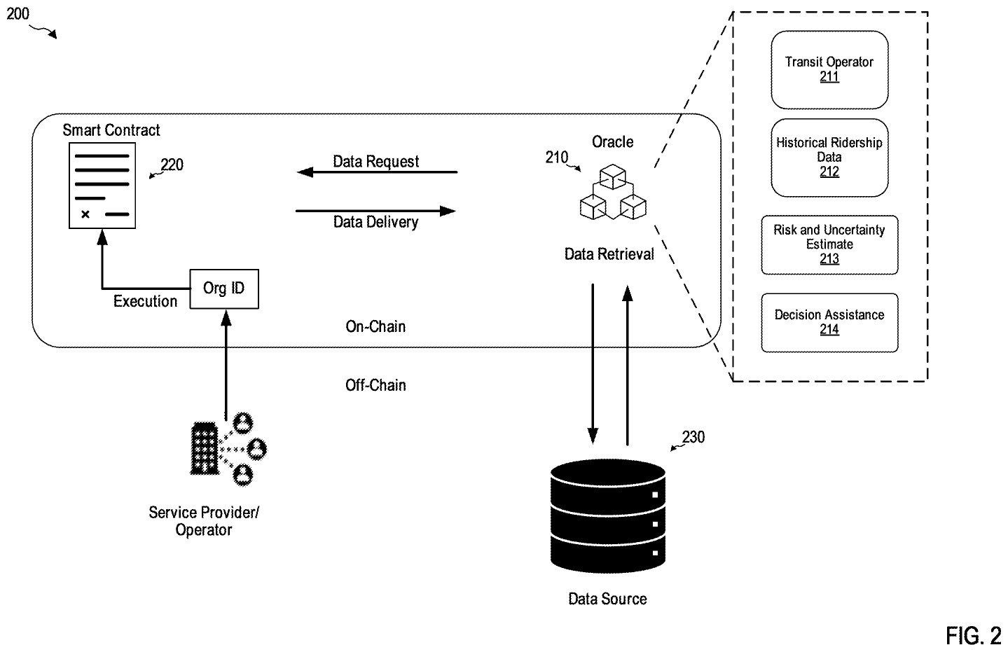

FIG. 2 is a diagram 200 illustrating an implementation of a system incorporating at least one blockchain oracle 210 in accordance with some aspects of the disclosure. In some aspects, blockchain oracles (e.g., blockchain oracle 210) are third-party services that provide smart contracts (e.g., smart contract 220) with external information from data sources (e.g., data source 230, such as API/Hardware IoT, sensors, trusted databases, and so on). The blockchain oracles, in some aspects, may serve as bridges between blockchains and the outside world. A significant problem in a blockchain based system, in some aspects, may be a problem of reaching a consensus between different market participants. For example, each market participant, in some aspects, may detect external information provided along with transaction data from the other market participants and/or partners and categorize them as “untrusted” sources leading to a rejection of the external (or extrinsic) information based on the categorization. Therefore, an oracle is introduced to receive information coming from the real world like the inputs and/or indicators from one or more trusted sensor networks associated with the multimodal traffic management system and the analytics derived based on the sensor network (e.g., at the oracle or at a trusted analytics component). In some aspects, the analytics and/or the oracle may be pre-verified by one or more market participants and the results of the analytics may be enforced via one or more smart contracts. The oracle (e.g., blockchain oracle 210) may then serve as a common trusted source for each operator and/or network participant. In some aspects, the blockchain oracle 210 may serve as a trusted source for one or more of transit operator data 211, historical ridership data 212, risk and uncertainty estimate data and/or module 213, and decision assistance information and/or module 214.

In some aspects, the at least one blockchain oracle 210 may collect and/or provide policy data such as carbon footprint data collected by a regulatory organization, an environmental organization, and/or a carbon trading platform. The blockchain oracles, in some aspects, may collect data from one or more off-chain sources, transfer the data on-chain with a signed message, and finally make data available by encoding it as a part of smart contract's storage/policy.

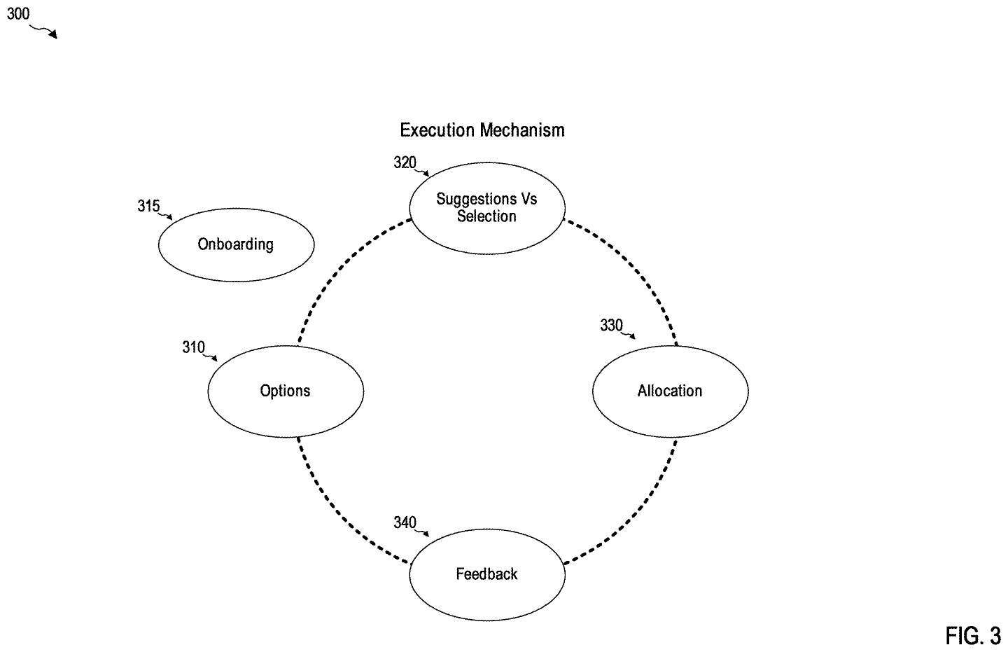

In some aspects, the system generates an automated service requirement suggestion list and service contract details for the most probable partners within the mobility ecosystem for a given time and location scope. FIG. 3 is a diagram 300 illustrating a high-level outline of an execution mechanism in accordance with some aspects of the disclosure. The execution mechanism may begin with a market participant (e.g., a transit network operator or service provider) selecting options at 310 for potential partners (e.g., other transit network operators or service providers with which the market participant is willing to partner to provide transportation services). Once the potential partners are selected at 310, the execution mechanism may perform an onboarding operation at 315 to integrate the market participant into a multimodal traffic management system (e.g., the multimodal operator market 101 of FIG. 1). The onboarding operation at 315 may include generating and/or updating a set of partner preferences, synchronizing information (e.g., current and/or historical ridership and/or demand information), defining objectives and/or goals, and/or defining parameters for participating in a SLA for the market participant.

Based on the onboarding operation at 315, the system may then, at 320, proceed to produce a set of suggestions for partnerships and receive one or more selections of partnerships to initiate (or to attempt to initiate) from the set of suggestions. After the selection at 320, the execution mechanism may allocate resources (e.g., may finalize agreements with other market participants to formalize obligations and record the terms and/or parameters associated with the agreements). After services and/or resources are allocated at 330, the services may be performed and/or resources provided and feedback regarding the interaction and/or transaction may be received at 340. For example, a set of characteristics of the service and/or resource provision, such as a timing of the provision, a cost of providing the services and/or resources, or other relevant characteristic for evaluating the performance of the partners to an agreement may be provided. Based on the feedback received at 340, the execution mechanism may then receive an update to the options selected by one or more market participant at 310 and may begin the cycle of generating suggestions at 320, allocating resources at 330, and receiving feedback at 340.

The suggestion list and service contract details, in some aspects, may be based on annual revenue, climate, and/or service criticality objectives. Approaches are provided in this disclosure to selectively integrate with various providers based on reliability factors, user preferences, and/or other criteria on a real time basis to facilitate a set of one or more dynamic real time partnerships between operators (e.g., market participants, service providers, and so on) and monitor the execution of the agreement. Based on the monitoring, the method and/or system may reevaluate the partnerships for setting conditions and/or parameters (e.g., operational costs and or time parameters) associated with future partnerships and/or SLAs. In some aspects, the method and/or system may facilitate service transactions between one or more mobility service providers and one or more transit operators to provide seamless mixed and/or multimodal fleet operation. The method and/or system, in some aspects, may provide automatic service request generation based on latent demand estimation and integrated multimodal traffic management system objectives. The automatic service request generation and other recommendations/and or suggestions may be based on historical service utilization data (e.g., ridership, fuel/utility consumption, maintenance) and location based contextual data from the multimodal transmit network to determine the latent demand estimates.

As discussed above, the method and/or system presented in the disclosure may achieve multimodal integration by providing a functional interlink between operational and institutional realm. The implementation of institutional integration may thereby be accelerated and transit operators may be able to realize the benefit of engagement in a multimodal mobility consortium. In some aspects of the disclosure, the institutional integration may be advanced by establishing a single truth across a multimodal mobility consortium (e.g., a group of participants in a multimodal transit marketplace or associated with the MaaS system) and creating a feedback loop between the operators and institutional players (e.g., between different participants in the multimodal transit marketplace in private and/or public sectors).

For example, the partnerships within the MaaS multimodal ecosystem may include partnerships between a public transit (PT) operator and a micro mobility (MM) and/or ride hailing service provider, between an operator and a support service provider, and/or between multiple operators and a support service provider. A partnership between a PT operator and a micro mobility and/or ride hailing service provider may enable service transfer to enhance realtime connectivity and service penetration for the PT operator and/or optimize ride miles and improve service returns for the MM service provider. The partnership between the PT operator and the MM service provider may also enable the participants to manage service disruption and congestion and/or to improve a ride-mile to revenue ratio. A partnership between an operator and a support service provider may provide smart contracts to manage servicing charges and/or may provide timely support service to avoid disruptions. A partnership between multiple operators and a support service provider may optimize the support service cost by sharing labor and/or utilities and/or may allow for emergency and disruption adoption.

In some aspects, the system may provide an operator-interest-level prediction. The operator-interest-level prediction, in some aspects may be based on a partnership service criticality factor evaluation based on simulated scenarios of partnership failure. For example, the simulated scenarios of partnership failure may include evaluation for (or of) (1) a lost operational service hour, (2) lost revenue/service returns, (3) labor overheads, (4) a utilized number of subsystems, and so on. The operator-interest-level prediction, in some aspects, may further be based on normalization over long term service impacts and expert feedback systems, a partnership probability and incentive evaluation factor.

A sample fractional ownership assignment for a set of m partners in the multimodal mobility ecosystem based on probability (a probability of service utilization and/or demand) in accordance with aspects of the disclosure may be derived based on the following method. A demand prediction may be generated based on a prior distribution function for all modalities. For example, Dₚᵣ(tᵢ, loc_{i,j})=Set of distributions for [Dm₁, Dm₂, . . . , Dmₙ, u] may describe a modal demand represented by modal selection probability or mode-based demand for a given location locᵢⱼ and time tᵢ, where u may represent the uncertainty in the ecosystem to account for changes in user behavior. In some aspects, prior to the assignment of fractional ownership for service allocation, the possible ownership ratio and demand conversion probability for the organizations participating in the blockchain setup may be estimated. The estimation may allow market participants to estimate their internal operational goals and projections (ridership, profit, etc.)

In some aspects, a single trip or a multimodal route of some X, users can be represented by R=Sequence of [Dₚᵣ₁, Dₚᵣ₂, . . . , Dₚᵣₙ, U(Dₚᵣ)]. Given the route, R, the method may include evaluating initialization, maintenance, and termination invariants. The method may further include exception testing to account for special service requirements placed by the service consumer and/or market participant). For example, given the route, R, the method may provide the marginal likelihood or the model evidence for the demand function with respect to a specific demand representation. For example, if Dₚᵣ₁(tᵢ, locᵢⱼ) and Dₚᵣ₂(tᵢ₊ₚ, loc_{i+p,j+q}), and the joint probability distribution for a route is presented via a graphical model with the stations as the nodes and edges as the route leg connecting the stations then the joint probability distribution (JPD) may be given by P(X₁, X₂, . . . , Xₙ)=Πᵢ₌₁ⁿP(Xᵢ|Πᵢ)=Πᵢ₌₁ⁿj_{(X}_{ᵢ}_{|Π}_{ᵢ}₎. Based on the above equations, in some aspects, conditional distributions for each mode may be estimated, and this becomes the value function for incentivization reinforcement learning (RL) model.

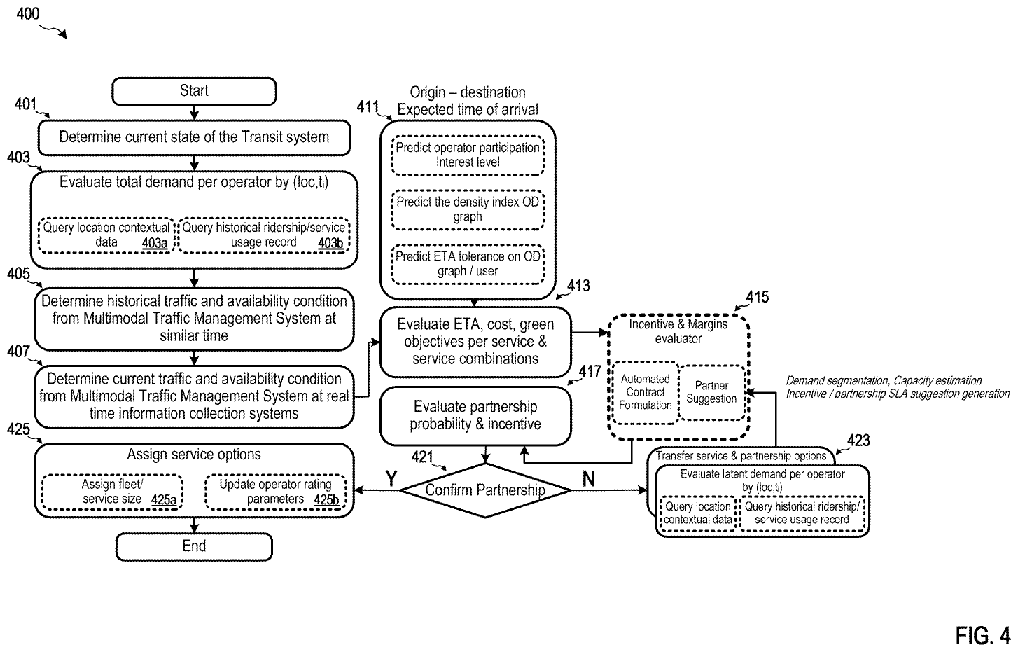

FIG. 4 is a diagram 400 illustrating a process performed by a MaaS system in accordance with some aspects of the disclosure. The MaaS system may, at 401, determine a current state of the multimodal transit system. The current state may include information regarding characteristics of a transit network associated with a location, such as whether the transit network is functioning or stopped, whether there are energy or fuel shortages, and whether a state has changed from a previous state. At 403, the MaaS system may, in some aspects, evaluate a total demand per operator at each location at a particular time (e.g., for a set of ordered pairs (locᵢⱼ, tᵢ)) to generate a demand model for the MaaS system. The demand model may be based on location contextual data 403a and/or historical ridership and/or service usage data 403b. The location contextual data 403a, in some aspects, may include and/or be based on information regarding population, a land use survey, relative income level, nearby services, nearest points of interest (grocery, work area, etc.) and other relevant factors.

After evaluating the total demand per operator at 403, the MaaS system may determine, at 405, historical traffic and availability condition from the multimodal traffic management system at a current or adjacent time. The historical traffic and availability conditions may identify previous demand for transportation and/or a service and an operator (or market participant) that fulfilled the demand. The historical traffic and availability data may be used to predict a probability of each operator providing a particular service identified by the MaaS system. The MaaS system may also determine, at 407, a current traffic and availability condition from the multimodal traffic management system in real time (or near-real time).

The MaaS system may generate, at 411, an origin-destination map and/or graph for an area based on historical traffic information and ridership and service usage. The origin-destination map and/or graph, may be used to identify different operators associated with a particular area and an interest level of the different operators for responding to a particular (predicted or identified) demand. At 411, the MaaS system may, in some aspects, predict a density index for the origin-destination map and/or graph that identifies an amount of demand for a particular origin-destination pair that may be used to determine a set of interested operators. For example, a ride-share or mini-mobility operator may be better suited, and more likely to respond, to provide transportation for a small number of users, or for last mile transportation, than a train or bus. Conversely, a large number of riders may be better served, in some aspects, by a train or bus operator between two disparate areas with mini-mobility operators supplying last-mile transportation. The MaaS system may, at 411, predict an estimated time of arrival (ETA) tolerance (or time-sensitivity) for a transportation (or utility) service identified for the origin-destination map and/or graph that identifies how sensitive the consumer (the rider or operator associated with the transportation or utility request, respectively) is to delays.

The MaaS system may then evaluate, at 413, the information associated with the origin-destination map and/or graph generated at 411, the state information determined at 401, the total demand information determined at 403, the historical traffic and availability information determined at 405, and the current traffic and availability information determined at 405 to determine a ranked set of likely partners. The evaluation may include a consideration of objectives and/or goals (e.g., green goals relating to carbon emissions, or other objective functions), costs, feedback from previous interactions, and other information used to evaluate an objective function for a set of possible partnerships. The ranked set of likely partners may be considered, at 415 to identify a set of partnerships that optimize the objective function. The set of partnerships may be ranked based on the value of the objective function associated with each partnership and a set of partner suggestions and SLA terms associated with each partnership may be presented to a market participant associated with a particular request or identified demand.

The MaaS system may further evaluate, at 417, a likelihood of an identified partner accepting a request to participate in an SLA (e.g., based on a presented cost, timing of the service, or other parameters) based on historical data and/or a set of identified incentives. At 412, the SLA may then be presented to an identified partner and, if the identified partner rejects the SLA (e.g., rejects a request to provide a service or resource), the MaaS system may reevaluate, at 423, the partner likelihood and perform the operations described above in relation to 415 to 421 to identify an updated partner suggestion and SLA terms and present them to the suggested partner. The process may be repeated until a partner accepts an SLA at 421. Once the agreement is accepted by both parties, the MaaS system may assign, at 425, service options (e.g., allocate resources associated with the services provided) according to the SLA. Assigning the service options at 425, in some aspects, may include assigning, at 425a, fleet resources. Based on the series of rejections and/or the acceptance of the one or more SLAs presented at 417 or 421, the MaaS system may update, at 425b, a set of operator rating parameters (e.g., an algorithm or machine-learning-trained network may be updated based on the terms that were rejected and/or accepted by the suggested partners). In some aspects, the partnership evaluation and confirmation at 417 and 421, may be automated based on known operator preferences (e.g., acceptance parameters and/or criteria) such that, the MaaS system may generate and execute an agreement between operators.

The MaaS system described above in relation to FIG. 4, in some aspects, may include blockchain oracles used to execute the probability-based partnership. Blockchain oracles, in some aspects, refer to any component that may provide external data to a smart contract (e.g., provide information to a system responsible for executing a smart contract). The blockchain oracles, in some aspects, may perform one or more of data normalization, data aggregation, data validation, or other related functions. For example, a blockchain, in some aspects, may link smart contracts to outside entity inputs that are accepted as validated inputs, such as sensor readings or/and meteorological data, or other external data (e.g., to generate a ground truth or objective set of facts for the execution of the smart contracts). The blockchain oracles may enable operators to collaborate with each other to serve a set of passengers while reducing operational costs and optimizing utilizations of assets. Collaboration among transit operators, in some aspects, may reduce energy consumption, carbon emissions, and increase profitability. For example, there may be a collaborative operator market with multiple agents who want to trade their transit resources or logistics tasks.

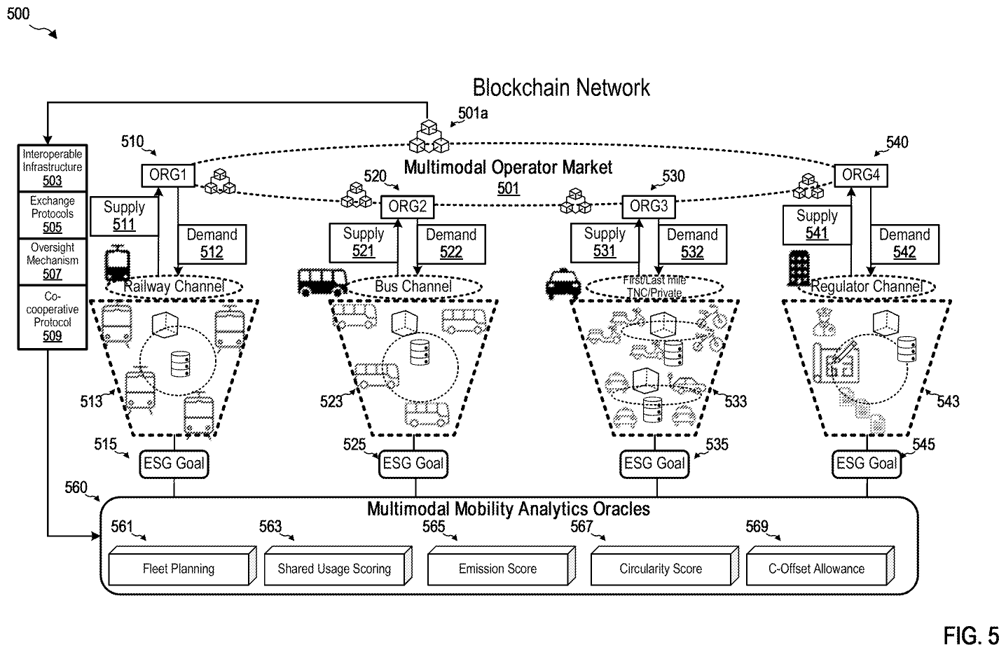

FIG. 5 is a diagram 500 illustrating a mechanism for marketplace operations in accordance with some aspects of the disclosure where the objectives (e.g., objectives used at 413 of FIG. 4) is related to energy saving and/or greenhouse gas emission goals (e.g., environmental, social, and governance (ESG) goals). While FIG. 5 is described in relation to energy saving and/or greenhouse gas emission goals, the particular application is not limiting and may be applied to one or more other goals defined by one or more marketplace participants. For example, each market participant may determine its own goals that may be different from the goals of other market participants. The operator market follows the following cycle for each allocation: information transfer, auction, incentives, winner determination, adherence, and feedback-service scoring. The allocations, may be determined for different time periods (e.g., yearly, monthly, day-to-day, hourly, and so on). For example, the railway operator 513, the bus operator 523, the first/last mile (or transit network company) operator 533, and/or regulator 543 may exchange supply information 511, 521, 531, and/or 541; demand information 512, 522, 532, and/or 542; and/or ESG goals 515, 525, 535, and/or 545, respectively. The information exchange may be performed, at least in part via a set of blockchain oracles 510, 520, 530, and/or 540.

Some of the components contributing to the multimodal operator market 501 and blockchain oracle 501a may include individual operator modules (e.g., component blockchain oracles 510, 520, 530, or 540). The blockchain oracle 501a may be associated with a set of functions, components, and/or algorithms (e.g., interoperable infrastructure 503, exchange protocols 505, oversight mechanism 507, and co-operative protocol 509) to provide a set of data for a set of multimodal mobility analytics oracles 560. Individual suggestions may be based and/or calculated for a service operator based on organization specific ESG goals.

In some aspects, the set of multimodal mobility analytics oracles 560 may include a fleet planning module 561 which may plan resourcing from clean energy vehicles and internal combustion engine vehicles for an operator. The set of multimodal mobility analytics oracles 560, in some aspects, may include shared usage scoring module 563 relating to vehicle occupancy-based usage metering to promote public transit and emission/congestion control. An emission score module 565, may be included in the set of multimodal mobility analytics oracles 560, and may be dependent on the fleet planning module 561 and the shared usage scoring module 563 and on a vehicle assigned to one or more high utility routes. The set of multimodal mobility analytics oracles 560, in some aspects, may include a circularity score module 567 that relates to the organization's effort to recovery and reuse of resources. A C-offset allowance module 569, may be included in the set of multimodal mobility analytics oracles 560, where the C-offset allowance module 569 may be related to local policy metrics and investment via carbon trading/planning or other sources that enables carbon offset.

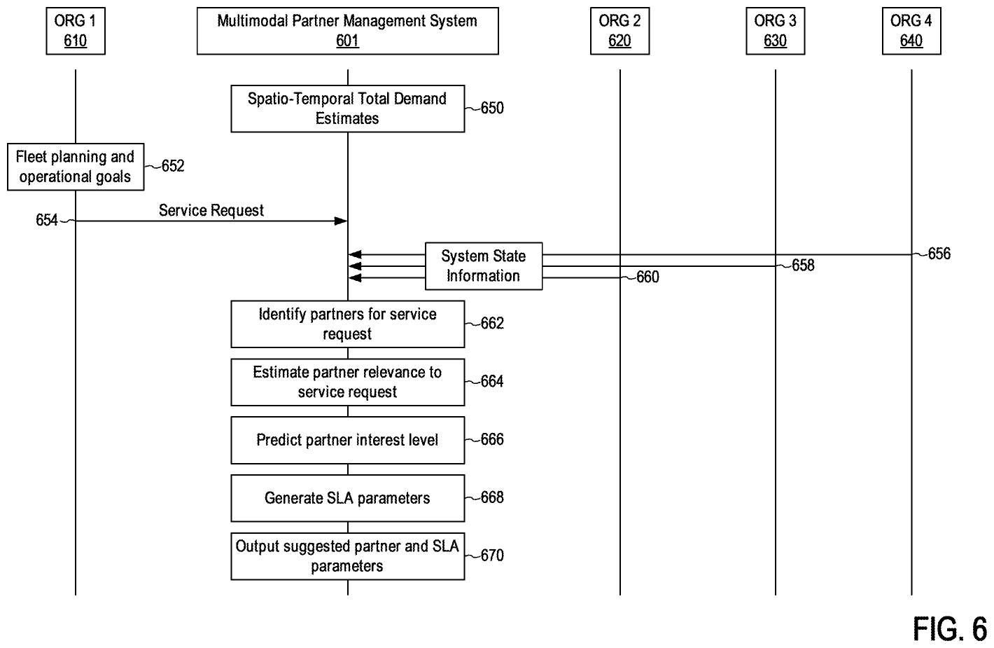

FIG. 6 is a call flow diagram illustrating example interactions between a MPMS 601, a first operator 610, a second operator 620, a third operator 630, and a fourth operator 640 for ridership-based partnerships in a mobility ecosystem in accordance with some aspects of the disclosure. In some aspects, the first operator 610 may be a train operator, a second operator 620 may be a bus operator, a third operator 630 may be a transit network company (e.g., an on-demand transportation provider), and a fourth operator 640 may be a resource provider (e.g., a grid management system operator). The MPMS 601, in some aspects, may generate spatio-temporal total demand estimates at 650 as discussed above in relation to operations 403-411 of FIG. 4.

The first operator 610, in some aspects, may define fleet planning and/or operational goals at 652. Based on the fleet planning and/or operational goals, the first operator 610 may generate a service request 654. The first operator, in some aspects, may transmit, and the MPMS 601 may receive, the service request 654 indicating a set of one or more services relating to one or more of maintenance, utilities, or ridership. For the following discussion, the service request 654 is assumed to relate primarily to ridership services. In some aspects, the service request 654 may also include any relevant updates to state information associated with the first operator 610. The service request 654, in some aspects, may be replaced by a service request (automatically) generated by the MPMS 601.

The MPMS 601 may then receive system state information from each market participant (e.g., may receive state information 656 from the fourth operator 640, state information 658 from the third operator 630, and state information 660 from the second operator 620). The state information 656-660, in some aspects, may be received in response to a request (not shown) from the MPMS 601, or may be received periodically or on an event-triggered basis (e.g., upon a change in state) from each operator independently. Based on the state information 656-660 and the service request 654, the MPMS 601 may identify, at 662, a set of potential partners for fulfilling the service request at a given time for a particular geographical location. For example, based on the service request 654 being related to ridership, or transportation, the MPMS may identify that the second operator 620 and the third operator 630 are potential partners based on being associated with transportation services.

For each identified potential partner, at 664, the MPMS 601 may estimate partner relevance to the service request 654. The MPMS 601 may rank the potential partners based on the estimated partner relevance. At 666, the MPMS 601, in some aspects, may predict a partner interest level in providing the service associated with the service request 654. The prediction at 666, in some aspects, may be based on parameters of the service request 654 (e.g., based on a presented cost, timing of the service, or other parameters) based on historical data and/or a set of identified incentives. Based on the predicted partner interest level analysis, the MPMS 601 may, at 668, generate parameters (or terms) for a SLA between the first operator 610 and, for example, the third operator 630. The terms may be generated at 668 to maximize the probability of acceptance by the first operator 610 and the third operator 630 based on the historical data and/or the set of identified incentives (e.g., goals or objectives provided by the different operators). At 670, the MPMS 601 may output the suggested partner and SLA parameters.

For example, the SLA parameters may include operational parameters such as fleet schedule, fleet route, fleet frequency, stop/wait time at a particular location for both the partners (the one initiating the request and the one executing the request). The SLA parameters, in some aspects, may include service conditions such as grid load, flow parameters or the cost of ride at a particular period. The above steps, in some aspects, provide the following benefits: estimation of service requirement from historical and contextual data, priority assignment for a service request, service class selection, service provider identification (e.g., from within the marketplace), ranking and/or rating of the different providers, option expression (e.g., auction, matching, and/or listing), service provider selection, service unit allocation, service utilization, and/or service rating (representing a feedback from a consumer of the service that is used to quantify an incentive associated with the service). In some aspects, option expression may be associated with setting up exchanges in a marketplace setting, e.g., identifying and/or generating information regarding service requirements, participants that can fulfill service requests, and an auction-based matching algorithm for assigning services to available participants in the ecosystem or marketplace.

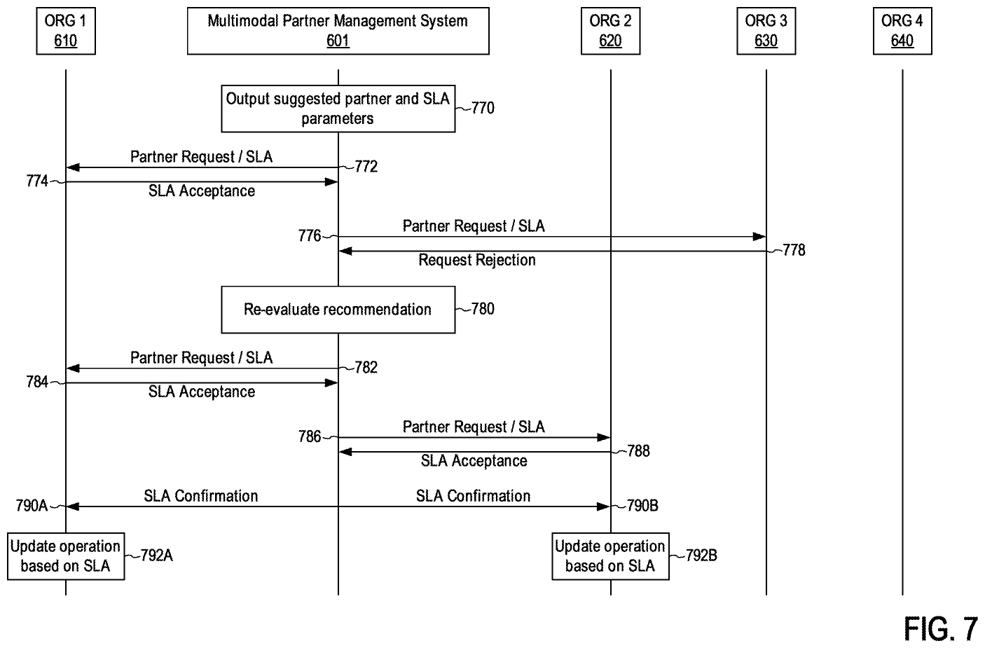

FIG. 7 illustrates a continuation of the example beginning in FIG. 6 in accordance with some aspects of the disclosure. In some aspects, outputting the suggested partner and SLA parameters at 670 may correspond to outputting the suggested partner and SLA parameters at 770. Outputting the suggested partner and SLA parameters at 670, in some aspects, may include transmitting the partner request and/or SLA 772 to the first operator 610. The first operator 610 may transmit, and the MPMS 601 may receive, SLA acceptance 774. Based on receiving the SLA acceptance 774, the MPMS 601 may transmit, and third operator 630 may receive, the partner request and/or SLA 776. The third operator 630 may determine not to provide the service. Accordingly, the third operator 630 may transmit, and MPMS 601 may receive, request rejection 778.

Based on the request rejection 778, the MPMS 601 may reevaluate the recommendation at 780 and generate a second recommendation for a partnership with the second operator 620 and a set of SLA parameters. The MPMS 601 may then transmit, and first operator 610 may receive, the partner request and/or SLA 782 to the first operator 610. The first operator 610 may transmit, and the MPMS 601 may receive, SLA acceptance 784. Based on receiving the SLA acceptance 784, the MPMS 601 may transmit, and second operator 620 may receive, the partner request and/or SLA 786. The second operator 620 may determine to accept the terms (or parameters) of the SLA 786 and may transmit, and MPMS 601 may receive, SLA acceptance 788. In some aspects, the SLAs between the partners may be executed as smart contracts.

Based on the SLA acceptances 784 and 788, the MPMS 601 may transmit to the first operator 610 and the second operator 620 a SLA confirmation 790A and SLA confirmation 790B, respectively. Based on the SLA confirmation 790A (or 790B), the first operator 610 (or the second operator 620) may update a planned operation at 792A (or 792B). The updated operation may include fleet planning, transfers of money, transfers of carbon credits, or other adjustments as dictated by the service request and SLA parameters.

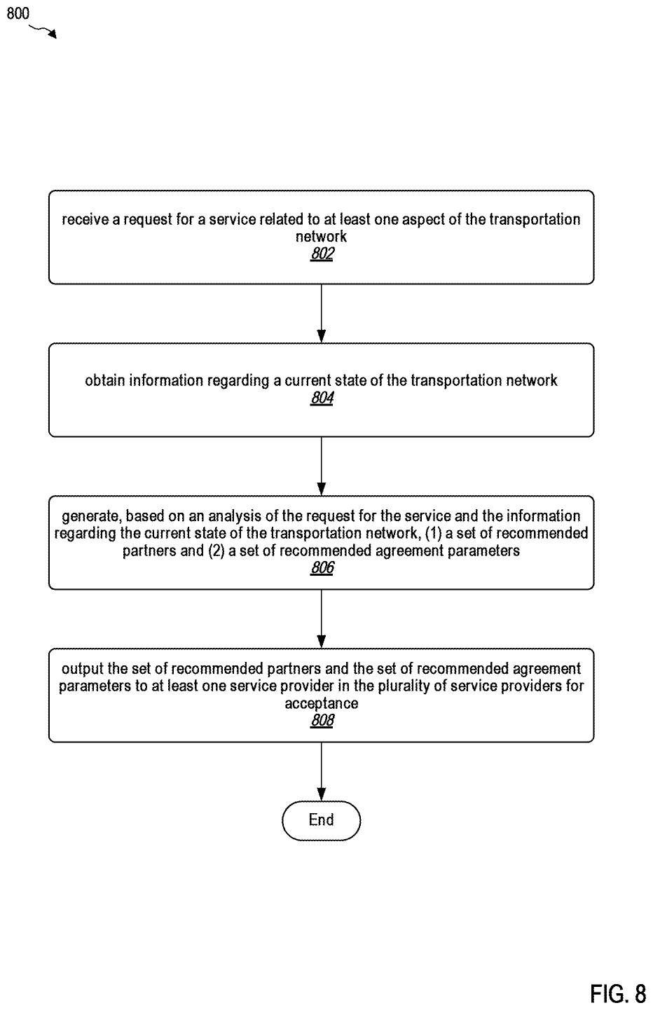

FIG. 8 is a flow diagram 800 illustrating a method in accordance with some aspects of the disclosure. In some aspects, the method is performed by an apparatus such as a multimodal mobility analytics oracle 160 or 560, or a MPMS 601 (e.g., implemented by one or more computing devices such as computing device 1005) that performs various analyses, predictions, and management operations for a multimodal transportation network. At 802, the apparatus may receive a request for a service related to at least one aspect of the transportation network. For example, referring to FIGS. 1, 4, 5, and 6, the multimodal mobility analytics oracle 160 or 560, or a MPMS 601 may receive a service request 654 (e.g., related to a demand identified by operations 403-411 and/or to a supply 511-541 and/or demand 512-542). The request, in some aspects, may be ‘received’ from a component of the system that identifies predicted or current demand (e.g., from a set of modules or components performing operations 403-411 of FIG. 4) and automatically generates the service request. In some aspects, the at least one aspect of the transportation network that is related to the at least one service request is one or more of maintenance, utilities, or ridership. For example, the service request may relate to providing on-demand (short-term) fleet maintenance in the case of greater than expected maintenance demands. A request for service related to utilities, in some aspects, may include a request for fuel or other resource (e.g., a carbon offset or other exchange of environmental credits). A request for ridership, in some aspects, may include an identification of a demand in excess of a particular operator's capacity and a request for transportation services for the excess riders. The request, in some aspects, may relate to transportation services and the information regarding the current state of the transportation network further includes current and historical ridership information for the plurality of service providers.

At 804, the apparatus may obtain information regarding a current state of the transportation network. The information regarding the current state of the transportation network, in some aspects, may include a set of service-preference parameters for the plurality of service providers. In some aspects, the set of service-preference parameters may include a set of incentives and costs associated with providing services. For example, referring to FIGS. 1, 4, 5, and 6, the multimodal mobility analytics oracle 160 or 560, or a MPMS 601 may obtain state information 656-660 (e.g., at 401, state information related to supply 511-541 and/or demand 512-542). Obtaining the information regarding the current state of the transportation network at 804, may include receiving current state data from one or more service providers in the plurality of service providers. In some aspects, the apparatus may identify, based on the request for the service received at 802, the one or more service providers as potential partner(s) for providing the service and may transmit at least one query to the one or more service providers. In some aspects, the current state data is received from the one or more service providers at 804 based on the at least one query.

At 806, the apparatus may generate (1) a set of recommended partners to provide the (transit-oriented) service and (2) a set of recommended agreement parameters associated with providing the (transit-oriented) service based on an analysis of the request for the service received at 802 and the information regarding the current state of the transportation network obtained at 804. For example, referring to FIGS. 1, 4, 5, and 6, the multimodal mobility analytics oracle 160 or 560, or a MPMS 601 may generate a set of recommended partners and a set of recommended SLA parameters at 662-668 (e.g., at 413-417, state information related to supply 511-541 and/or demand 512-542). In some aspects, the apparatus may generate the set of recommended partners by calculating, based on the current and historical ridership information, a probability for each of a set of transportation providers in the plurality of service providers to provide the transportation services requested and identifying the set of recommended partners based on the probability calculated for each of the set of transportation providers. The probability for each of the set of transportation providers in the plurality of service providers to provide the transportation services requested, in some aspects, may be based on a set of objective functions. In some aspects, the set of objective functions may relate to one or more of fuel consumption, maintenance requirements, reliability of service, or trip time. Generating the set of recommended partners, in some aspects, may be based on optimizing a value proposition for each recommended partner in the set of recommended partners based on the set of incentives and costs associated with the recommended partner.

At 808, the apparatus may output the set of recommended partners and the set of recommended agreement parameters to at least one service provider in the plurality of service providers for acceptance. For example, referring to FIGS. 1, 4, 5, and 6, the multimodal mobility analytics oracle 160 or 560, or a MPMS 601 may output the set of recommended partners and/or the set of recommended SLA parameters (e.g., at 421, at 670 or 772) to the first operator 610. The set of recommended partners and the set of recommended agreement parameters, in some aspects, may include multiple sets of recommended partners and associated sets of recommended agreement parameters from which the at least one service provider may select a (recommended) partner and associated set of (recommended) agreement parameters.

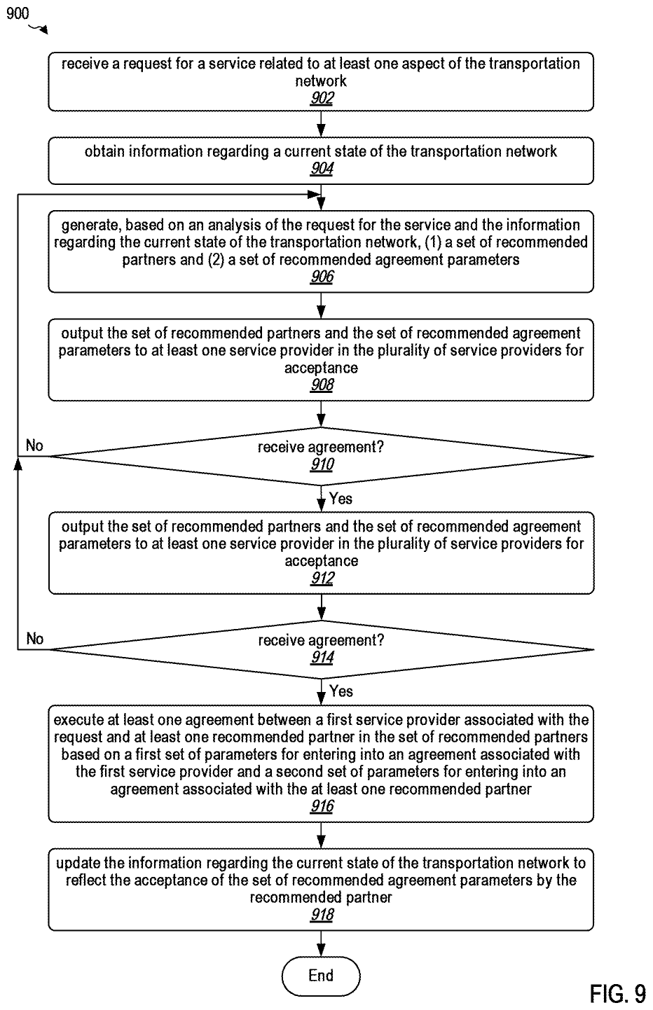

FIG. 9 is a flow diagram 900 illustrating a method in accordance with some aspects of the disclosure. In some aspects, the method is performed by an apparatus such as a multimodal mobility analytics oracle 160 or 560, or a MPMS 601 (e.g., implemented by one or more computing devices such as computing device 1005) that performs various analyses, predictions, and management operations for a multimodal transportation network. At 902, the apparatus may receive a request for a service related to at least one aspect of the transportation network. For example, referring to FIGS. 1, 4, 5, and 6, the multimodal mobility analytics oracle 160 or 560, or a MPMS 601 may receive a service request 654 (e.g., related to a demand identified by operations 403-411 and/or to a supply 511-541 and/or demand 512-542). The request, in some aspects, may be ‘received’ from a component of the system that identifies predicted or current demand (e.g., from a set of modules or components performing operations 403-411 of FIG. 4) and automatically generates the service request. In some aspects, the at least one aspect of the transportation network that is related to the at least one service request is one or more of maintenance, utilities, or ridership. For example, the service request may relate to providing on-demand (short-term) fleet maintenance in the case of greater than expected maintenance demands. A request for service related to utilities, in some aspects, may include a request for fuel or other resource (e.g., a carbon offset or other exchange of environmental credits). A request for ridership, in some aspects, may include an identification of a demand in excess of a particular operators capacity and a request for transportation services for the excess riders. The request, in some aspects, may relate to transportation services and the information regarding the current state of the transportation network further includes current and historical ridership information for the plurality of service providers.

At 904, the apparatus may obtain information regarding a current state of the transportation network. The information regarding the current state of the transportation network, in some aspects, may include a set of service-preference parameters for the plurality of service providers. In some aspects, the set of service-preference parameters may include a set of incentives and costs associated with providing services. For example, referring to FIGS. 1, 4, 5, and 6, the multimodal mobility analytics oracle 160 or 560, or a MPMS 601 may obtain state information 656-660 (e.g., at 401, state information related to supply 511-541 and/or demand 512-542). Obtaining the information regarding the current state of the transportation network at 904, may include receiving current state data from one or more service providers in the plurality of service providers. In some aspects, the apparatus may identify, based on the request for the service received at 902, the one or more service providers as potential partner(s) for providing the service and may transmit at least one query to the one or more service providers. In some aspects, the current state data is received from the one or more service providers at 904 based on the at least one query.

At 906, the apparatus may generate (1) a set of recommended partners to provide the (transit-oriented) service and (2) a set of recommended agreement parameters associated with providing the (transit-oriented) service based on an analysis of the request for the service received at 902 and the information regarding the current state of the transportation network obtained at 904. For example, referring to FIGS. 1, 4, 5, and 6, the multimodal mobility analytics oracle 160 or 560, or a MPMS 601 may generate a set of recommended partners and a set of recommended SLA parameters at 662-668 (e.g., at 413-417, state information related to supply 511-541 and/or demand 512-542). In some aspects, the apparatus may generate the set of recommended partners by calculating, based on the current and historical ridership information, a probability for each of a set of transportation providers in the plurality of service providers to provide the transportation services requested and identifying the set of recommended partners based on the probability calculated for each of the set of transportation providers. The probability for each of the set of transportation providers in the plurality of service providers to provide the transportation services requested, in some aspects, may be based on a set of objective functions. In some aspects, the set of objective functions may relate to one or more of fuel consumption, maintenance requirements, reliability of service, or trip time. Generating the set of recommended partners, in some aspects, may be based on optimizing a value proposition for each recommended partner in the set of recommended partners based on the set of incentives and costs associated with the recommended partner.

At 908, the apparatus may output the set of recommended partners and the set of recommended agreement parameters to at least one service provider in the plurality of service providers for acceptance. For example, referring to FIGS. 1, 4, 5, and 6, the multimodal mobility analytics oracle 160 or 560, or a MPMS 601 may output the set of recommended partners and/or the set of recommended SLA parameters (e.g., at 421, at 670 or 772) to the first operator 610. The set of recommended partners and the set of recommended agreement parameters, in some aspects, may include multiple sets of recommended partners and associated sets of recommended agreement parameters from which the at least one service provider may select a (recommended) partner and associated set of (recommended) agreement parameters. In some aspects, the at least one service provider may be a service provider associated with the service request (e.g., the service provider requesting the service).

At 910, the apparatus may determine whether an agreement has been received from the at least one service provider associated with the service request. If the apparatus determines, at 910, that the agreement has not been received (e.g., has been rejected), the apparatus may return to 906 to generate a (1) a new set of recommended partners and (2) a new set of recommended agreement parameters based on an analysis of the request for the service received at 902 and the information regarding the current state of the transportation network obtained at 904. If, at 910, the apparatus determines that the agreement has been received, the apparatus may output, at 912, the set of recommended partners and the set of recommended agreement parameters to at least one (additional) service provider in the plurality of service providers (e.g., a service provider associated with providing the requested service) for acceptance. For example, referring to FIGS. 1, 4, 5, and 7, the multimodal mobility analytics oracle 160 or 560, or a MPMS 601 may output the set of recommended partners and/or the set of recommended SLA parameters (e.g., at 421, at 776) to the third operator 630.

At 914, the apparatus may determine whether an agreement has been received from the at least one (additional) service provider in the plurality of service providers (e.g., a service provider associated with providing the requested service). If the apparatus determines, at 914, that the agreement has not been received (e.g., has been rejected), the apparatus may return to 906 to generate a (1) a new set of recommended partners and (2) a new set of recommended agreement parameters based on an analysis of the request for the service received at 902 and the information regarding the current state of the transportation network obtained at 904. If, at 914, the apparatus determines that the agreement has been received, the apparatus may execute, at 916, at least one agreement between a first service provider associated with the request and at least one recommended partner in the set of recommended partners based on a first set of parameters for entering into an agreement associated with the first service provider and a second set of parameters for entering into an agreement associated with the at least one recommended partner. The first and second sets of parameters, in some aspects are the set of recommended agreement parameters. Executing the agreement may include registering the agreement with a blockchain for maintaining state information and monitoring agreement fulfilment. At 918, the apparatus may update the information regarding the current state of the transportation network (e.g., in the blockchain) to reflect the acceptance of the set of recommended agreement parameters by the recommended partner(s).

In some aspects, the system described above may maximize passenger experience (or rewards) by minimizing wait times, reducing a number of transactions per trip, making transitions between modes of transportation easier. The system described above, in some aspects, may maximize demand scope (e.g., a total addressable demand by the service providers) and latent demand utilization. As discussed above, the system may be used to identify an ideal (or optimized) set of one or more collaborators (or partners).

The system, in some aspects, may also enable real time planning for optimized distribution of on-demand (Flex) and fixed services, optimized price point for on-demand services, generation of utility/service tokens based on fractional asset ownership (e.g., enabling digitalization of the operators).

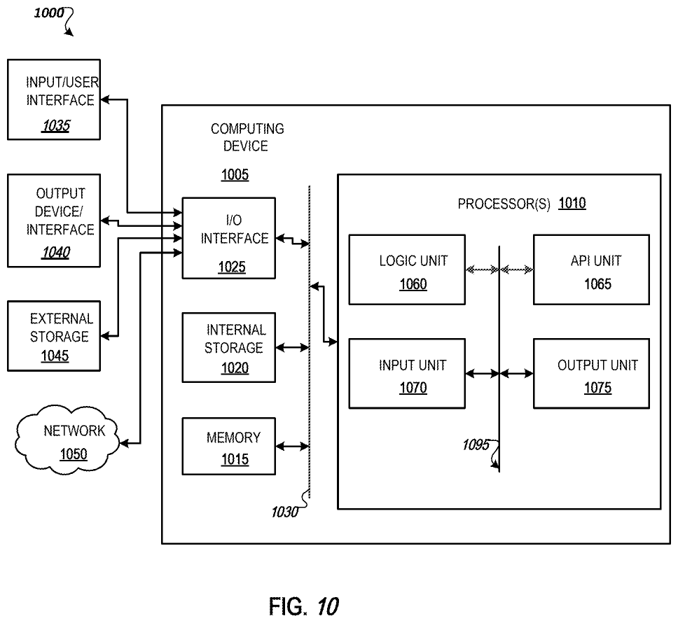

FIG. 10 illustrates an example computing environment with an example computer device suitable for use in some example implementations. Computer device 1005 in computing environment 1000 can include one or more processing units, cores, or processors 1010, memory 1015 (e.g., RAM, ROM, and/or the like), internal storage 1020 (e.g., magnetic, optical, solid-state storage, and/or organic), and/or IO interface 1025, any of which can be coupled on a communication mechanism or bus 1030 for communicating information or embedded in the computer device 1005. IO interface 1025 is also configured to receive images from cameras or provide images to projectors or displays, depending on the desired implementation.

Computer device 1005 can be communicatively coupled to input/user interface 1035 and output device/interface 1040. Either one or both of the input/user interface 1035 and output device/interface 1040 can be a wired or wireless interface and can be detachable. Input/user interface 1035 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1040 may include a display, television, monitor, printer, speaker, braille, or the like. In some example implementations, input/user interface 1035 and output device/interface 1040 can be embedded with or physically coupled to the computer device 1005. In other example implementations, other computer devices may function as or provide the functions of input/user interface 1035 and output device/interface 1040 for a computer device 1005.

Examples of computer device 1005 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1005 can be communicatively coupled (e.g., via IO interface 1025) to external storage 1045 and network 1050 for communicating with any number of networked components, devices, and systems, including one or more computer devices of the same or different configuration. Computer device 1005 or any connected computer device can be functioning as, providing services of, or referred to as a server, client, thin server, general machine, special-purpose machine, or another label.

IO interface 1025 can include but is not limited to, wired and/or wireless interfaces using any communication or IO protocols or standards (e.g., Ethernet, 1002.11x, Universal System Bus, WiMax, modem, a cellular network protocol, and the like) for communicating information to and/or from at least all the connected components, devices, and network in computing environment 1000. Network 1050 can be any network or combination of networks (e.g., the Internet, local area network, wide area network, a telephonic network, a cellular network, satellite network, and the like).

Computer device 1005 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1005 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 1010 can execute under any operating system (OS) (not shown), in a native or virtual environment. One or more applications can be deployed that include logic unit 1060, application programming interface (API) unit 1065, input unit 1070, output unit 1075, and inter-unit communication mechanism 1095 for the different units to communicate with each other, with the OS, and with other applications (not shown). The described units and elements can be varied in design, function, configuration, or implementation and are not limited to the descriptions provided. Processor(s) 1010 can be in the form of hardware processors such as central processing units (CPUs) or in a combination of hardware and software units.

In some example implementations, when information or an execution instruction is received by API unit 1065, it may be communicated to one or more other units (e.g., logic unit 1060, input unit 1070, output unit 1075). In some instances, logic unit 1060 may be configured to control the information flow among the units and direct the services provided by API unit 1065, the input unit 1070, the output unit 1075, in some example implementations described above. For example, the flow of one or more processes or implementations may be controlled by logic unit 1060 alone or in conjunction with API unit 1065. The input unit 1070 may be configured to obtain input for the calculations described in the example implementations, and the output unit 1075 may be configured to provide an output based on the calculations described in example implementations.

Processor(s) 1010 can be configured to receive a request for a service related to at least one aspect of the transportation network. The processor(s) 1010 can be configured to obtain information regarding a current state of the transportation network, where the information regarding the current state of the transportation network includes a set of service-preference parameters for the plurality of service providers. The processor(s) 1010 can be configured to generate, based on an analysis of the request for the service and the information regarding the current state of the transportation network, (1) a set of recommended partners to provide the (transit-oriented) service and (2) a set of recommended agreement parameters. The processor(s) 1010 can be configured to output the set of recommended partners and the set of recommended agreement parameters to at least one service provider in the plurality of service providers for acceptance.

The processor(s) 1010 can also be configured to receive current state data from one or more service providers in the plurality of service providers. The processor(s) 1010 can also be configured to identify, based on the request for the service, the one or more service providers as a potential partner for providing the service. The processor(s) 1010 can also be configured to transmit at least one query to the one or more service providers, wherein the current state data is received from the one or more service providers based on the at least one query. The processor(s) 1010 can also be configured to calculate, based on the current and historical ridership information, a probability for each of a set of transportation providers in the plurality of service providers to provide the transportation services requested. The processor(s) 1010 can also be configured to identify the set of recommended partners based on the probability calculated for each of the set of transportation providers. The processor(s) 1010 can also be configured to execute at least one agreement between a first service provider associated with the request and at least one recommended partner in the set of recommended partners based on a first set of parameters for entering into an agreement associated with the first service provider and a second set of parameters for entering into an agreement associated with the at least one recommended partner. The processor(s) 1010 can also be configured to receive an indication that the at least one service provider accepts the set of recommended agreement parameters. The processor(s) 1010 can also be configured to update the information regarding the current state of the transportation network to reflect the acceptance of the set of recommended agreement parameters by the recommended partner. The processor(s) 1010 can also be configured to receive a first indication that the first recommended partner rejects the set of recommended agreement parameters. The processor(s) 1010 can also be configured to output the set of recommended agreement parameters to at least a second recommended partner. The processor(s) 1010 can also be configured to receive a second indication that the second recommended partner accepts the set of recommended agreement parameters. The processor(s) 1010 can also be configured to update the information regarding the current state of the transportation network to reflect the rejection of the set of recommended agreement parameters by the first recommended partner and the acceptance of the set of recommended agreement parameters by the second recommended partner.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method of providing service partner recommendations in a transportation network associated with a plurality of transit-oriented service providers, the method comprising:
receiving a request for a service related to at least one aspect of the transportation network;
obtaining information regarding a current state of the transportation network, wherein the information regarding the current state of the transportation network comprises a set of service-preference parameters for the plurality of transit-oriented service providers;
generating, based on an analysis of the request for the service and the information regarding the current state of the transportation network, (1) a set of recommended partners to provide the service and (2) a set of recommended agreement parameters associated with providing the service; and
outputting the set of recommended partners and the set of recommended agreement parameters to at least one service provider in the plurality of transit-oriented service providers for acceptance.

2. The method of claim 1, wherein the at least one aspect of the transportation network is one or more of maintenance, utilities, or ridership.

3. The method of claim 1, wherein obtaining the information regarding the current state of the transportation network comprises:
receiving current state data from one or more service providers in the plurality of transit-oriented service providers.

4. The method of claim 3, wherein obtaining the information regarding the current state of the transportation network comprises:
identifying, based on the request for the service, the one or more service providers as a potential partner for providing the service; and
transmitting at least one query to the one or more service providers, wherein the current state data is received from the one or more service providers based on the at least one query.

5. The method of claim 1, wherein the request relates to transportation services, the information regarding the current state of the transportation network further comprises current and historical ridership information for the plurality of transit-oriented service providers, and generating the set of recommended partners comprises:
calculating, based on the current and historical ridership information, a probability for each of a set of transportation providers in the plurality of transit-oriented service providers to provide the transportation services requested; and
identifying the set of recommended partners based on the probability calculated for each of the set of transportation providers.

6. The method of claim 5, wherein the probability for each of the set of transportation providers in the plurality of transit-oriented service providers to provide the transportation services requested is further based on a set of objective functions, the set of objective functions relating to one or more of fuel consumption, maintenance requirements, reliability of service, or trip time.

7. The method of claim 1, wherein the set of service-preference parameters comprises a set of incentives and costs associated with providing services, and generating the set of recommended partners is further based on optimizing a value proposition for each recommended partner in the set of recommended partners based on the set of incentives and costs associated with the recommended partner.

8. The method of claim 1, wherein the set of service-preference parameters comprises a set of parameters associated with each service provider for entering into an agreement, the method further comprising:
executing at least one agreement between a first service provider associated with the request and at least one recommended partner in the set of recommended partners based on a first set of parameters for entering into an agreement associated with the first service provider and a second set of parameters for entering into an agreement associated with the at least one recommended partner.

9. The method of claim 1, wherein the at least one service provider in the plurality of transit-oriented service providers comprises a recommended partner, the method further comprising:
receiving an indication that the at least one service provider accepts the set of recommended agreement parameters; and
updating the information regarding the current state of the transportation network to reflect the acceptance of the set of recommended agreement parameters by the recommended partner.

10. The method of claim 1, wherein the at least one service provider in the plurality of transit-oriented service providers comprises a first recommended partner, the method further comprising:
receiving a first indication that the first recommended partner rejects the set of recommended agreement parameters;
outputting the set of recommended agreement parameters to at least a second recommended partner;
receiving a second indication that the second recommended partner accepts the set of recommended agreement parameters; and
updating the information regarding the current state of the transportation network to reflect the first indication that the first recommended partner rejects the set of recommended agreement parameters by the first recommended partner and the acceptance of the set of recommended agreement parameters by the second recommended partner.

11. A computer-readable medium storing computer executable code for providing service partner recommendations in a transportation network associated with a plurality of transit-oriented service providers, the computer executable code when executed by a processor causes the processor to:
receive a request for a service related to at least one aspect of the transportation network;
obtain information regarding a current state of the transportation network, where the information regarding the current state of the transportation network includes a set of service-preference parameters for the plurality of transit-oriented service providers;
generate, based on an analysis of the request for the service and the information regarding the current state of the transportation network, (1) a set of recommended partners to provide the service and (2) a set of recommended agreement parameters associated with providing the service; and
output the set of recommended partners and the set of recommended agreement parameters to at least one service provider in the plurality of transit-oriented service providers for acceptance.

12. The computer-readable medium of claim 11, wherein the at least one aspect of the transportation network is one or more of maintenance, utilities, or ridership.

13. The computer-readable medium of claim 11, wherein the computer executable code causing the processor to obtain the information regarding the current state of the transportation network comprises computer executable code that, when executed by the processor, causes the processor to:
receive current state data from one or more service providers in the plurality of transit-oriented service providers.

14. The computer-readable medium of claim 13, wherein the computer executable code causing the processor to obtain the information regarding the current state of the transportation network comprises computer executable code that, when executed by the processor, causes the processor to:
identify, based on the request for the service, the one or more service providers as a potential partner for providing the service; and
transmit at least one query to the one or more service providers, wherein the current state data is received from the one or more service providers based on the at least one query.

15. The computer-readable medium of claim 11, wherein the request relates to transportation services, the information regarding the current state of the transportation network further comprises current and historical ridership information for the plurality of transit-oriented service providers, and the computer executable code causing the processor to generate the set of recommended partners comprises computer executable code that, when executed by the processor, causes the processor to:
calculate, based on the current and historical ridership information, a probability for each of a set of transportation providers in the plurality of transit-oriented service providers to provide the transportation services requested; and
identify the set of recommended partners based on the probability calculated for each of the set of transportation providers.

16. The computer-readable medium of claim 15, wherein the probability for each of the set of transportation providers in the plurality of transit-oriented service providers to provide the transportation services requested is further based on a set of objective functions, the set of objective functions relating to one or more of fuel consumption, maintenance requirements, reliability of service, or trip time.

17. The computer-readable medium of claim 11, wherein the set of service-preference parameters comprises a set of incentives and costs associated with providing services, and generating the set of recommended partners is further based on optimizing a value proposition for each recommended partner in the set of recommended partners based on the set of incentives and costs associated with the recommended partner.

18. The computer-readable medium of claim 11, wherein the set of service-preference parameters comprises a set of parameters associated with each service provider for entering into an agreement, and the computer executable code, when executed by the processor, further causes the processor to:
execute at least one agreement between a first service provider associated with the request and at least one recommended partner in the set of recommended partners based on a first set of parameters for entering into an agreement associated with the first service provider and a second set of parameters for entering into an agreement associated with the at least one recommended partner.

19. The computer-readable medium of claim 11, wherein the at least one service provider in the plurality of transit-oriented service providers comprises a recommended partner, and the computer executable code, when executed by the processor, further causes the processor to:
receive an indication that the at least one service provider accepts the set of recommended agreement parameters; and
update the information regarding the current state of the transportation network to reflect the acceptance of the set of recommended agreement parameters by the recommended partner.

20. The computer-readable medium of claim 11, wherein the at least one service provider in the plurality of transit-oriented service providers comprises a first recommended partner, and the computer executable code, when executed by the processor, further causes the processor to:
receive a first indication that the first recommended partner rejects the set of recommended agreement parameters;
output the set of recommended agreement parameters to at least a second recommended partner;
receive a second indication that the second recommended partner accepts the set of recommended agreement parameters; and
update the information regarding the current state of the transportation network to reflect the first indication that the first recommended partner rejects the set of recommended agreement parameters by the first recommended partner and the acceptance of the set of recommended agreement parameters by the second recommended partner.
